(19) United States
(12) Patent Application Publication
(10) Pub. No.: US 2011/0234837 A1
(43) Pub. Date: Sep. 29, 2011

(54) RECEIVING APPARATUS, RECEIVING METHOD, PROGRAM AND TRANSMITTING APPARATUS

(75) Inventor: Kazuya Yokoyama, Chiba (JP)

(73) Assignee: Sony Corporation, Tokyo (JP)

(21) Appl. No.: 13/048,995

(22) Filed: Mar. 16, 2011

(30) Foreign Application Priority Data
Mar. 25, 2010 (JP) 2010-070263

(51) Int. Cl. H04N 5/228

(52) U.S. Cl. 348/222.1; 348/E05.031

(57) ABSTRACT

A receiving apparatus includes: a communication unit performing communication with a transmitting apparatus as a transmission source of contents; and a control unit acquiring remaining drive time of the apparatus itself calculated based on a battery remaining amount of the apparatus itself and time necessary for transmitting the contents to compare the remaining drive time with the necessary time when receiving the contents from the transmitting apparatus through the communication unit and recording the contents in a storage unit, and selecting any one of a first mode in which part of the contents is received from the transmitting apparatus through the communication unit and recorded in the storage unit and a second mode in which reception of the contents is not performed when determining that the necessary time is longer than the remaining drive time based on the compared result.

### BACKGROUND OF THE INVENTION

1. Field of the Invention

The present invention relates to a receiving apparatus, a receiving method, a program and a transmitting apparatus.

2. Description of the Related Art

In moving image/still image recording and reproducing apparatus such as a camcorder and a digital still camera, an application of dubbing and storing contents recorded by a user into apparatus other than the recording apparatus is requested. Along with the request, apparatus or media to be used as dubbing destinations become diverse, and there may be a case where a dubbing destination is connected to an apparatus as a dubbing source by USB connection or wireless technique in addition to a case where both a medium as the dubbing source and a medium as the dubbing destination exist in the apparatus.

A relation between power supply and contents to be dubbed will be a problem when realizing the above. There occurs a case where it is difficult to perform dubbing desired by a user because of reduction of electric power during dubbing when it is necessary to supply electric power to the apparatus or the medium as the dubbing destination connected by USB from the apparatus as the dubbing source or when using wireless technique. This concern is prominent particularly in a case of battery driving. The dubbing is performed when the user desires to escape or store contents to other apparatus/media, however, there may be a case where the dubbing itself is difficult to be performed or a case where the content obtained by dubbing stops in the middle when a battery remaining amount is small.

As a technique concerning power supply at the time of dubbing, for example, there is a technique disclosed in JP-A-2007-280599 (Patent Document 1). In the technique disclosed in Patent Document 1, dubbing is restricted when power supply is reduced to a certain level.

### SUMMARY OF THE INVENTION

However, when executing dubbing of contents, there is a request to increase user-friendliness of dubbing by preferentially completing the dubbing of contents determined to have high priority even when the battery remaining amount is small. From this point of view, it is difficult to satisfy the request in the technique disclosed in Patent Document 1 because the dubbing is restricted when the battery remaining amount is small.

In view of the above, it is desirable to provide a novel and improved receiving apparatus, a receiving method, a program and a transmitting apparatus capable of selecting transmission of part of contents from the transmitting apparatus to the receiving apparatus even when the battery remaining amount is small.

According to one embodiment of the invention, there is provided an receiving apparatus including a communication unit performing communication with a transmitting apparatus as a transmission source of contents and a control unit acquiring remaining drive time of the apparatus itself calculated based on a battery remaining amount of the apparatus itself and time necessary for transmitting the contents to compare the remaining drive time with the necessary time when receiving the contents from the transmitting apparatus through the communication unit and recording the contents in a storage unit, and selecting any one of a first mode in which part of the contents is received from the transmitting apparatus through the communication unit and recorded in the storage unit and a second mode in which reception of the contents is not performed when determining that the necessary time is longer than the remaining drive time based on the compared result.

The control unit may select a given parameter for selecting part of the contents from the contents and transmit the selected given parameter to the transmitting apparatus through the communication unit.

The control unit may receive the battery remaining amount of the transmitting apparatus from the transmitting apparatus through the communication unit and select any smaller one of remaining drive time of the transmitting apparatus calculated based on the received battery remaining amount and the remaining drive time of the apparatus itself to be used for comparison between the selected remaining drive time and the necessary time.

The control unit may receive time necessary for transmitting the contents calculated based on a data size of the contents from the transmitting apparatus through the communication unit and acquire the received time as the necessary time.

The control unit may receive a data size of the contents from the transmitting apparatus through the communication unit and calculate time necessary for transmitting the contents based on the data size of the received contents to acquire the calculated time as the necessary time.

The receiving apparatus may further include a display unit displaying a selection screen for selecting any one of the first mode and the second mode.

The display unit may include the necessary time in the selection screen as well as including the remaining drive time in the selection screen.

The receiving apparatus further includes an operation unit receiving input of operation information from a user, in which the control unit may select any one of the first mode and the second mode based on the operation information the input of which is received by the operation unit.

The control unit may receive part of the contents and store the contents in the storage unit when selecting the first mode, and does not receive the contents when selecting the second mode.

According to another embodiment of the invention, there is provided a receiving method including the step of allowing a control unit of a receiving apparatus including a communication unit performing communication with a transmitting apparatus as a transmission source of contents and the control unit to acquire remaining drive time of the apparatus calculated based on a battery remaining amount of the apparatus and time necessary for transmitting the contents to compare the remaining drive time with the necessary time when receiving the contents from the transmitting apparatus through the communication unit and recording the contents in a storage unit, and select any one of a first mode in which part of the contents is received from the transmitting apparatus through the communication unit and recorded in the storage unit and a second mode in which reception of the contents is not performed when determining that the necessary time is longer than the remaining drive time based on the compared result.

According to still another embodiment of the invention, there is provided a program for allowing a computer to function as a receiving apparatus including a communication unit performing communication with a transmitting apparatus as a transmission source of contents, and a control unit acquiring remaining drive time of the apparatus itself calculated based on a battery remaining amount of the apparatus itself and time necessary for transmitting the contents to compare the remaining drive time with the necessary time when receiving the contents from the transmitting apparatus through the communication unit and recording the contents in a storage unit, and selecting any one of a first mode in which part of the contents is received from the transmitting apparatus through the communication unit and recorded in the storage unit and a second mode in which reception of the contents is not performed when determining that the necessary time is longer than the remaining drive time based on the compared result.

According to yet another embodiment of the invention, there is provided a transmitting apparatus including a communication unit performing communication with a receiving apparatus as a transmission destination of contents and a control unit acquiring remaining drive time of the apparatus itself calculated based on a battery remaining amount of the apparatus itself and time necessary for transmitting the contents to compare the remaining drive time with the necessary time when transmitting the contents to the receiving apparatus through the communication unit, and selecting any one of a first mode in which part of the contents is transmitted to the receiving apparatus through the communication unit and recorded in a storage unit of the receiving apparatus and a second mode in which transmission of contents is not performed when determining that the necessary time is longer than the remaining drive time based on the compared result.

The control unit selects a given parameter for selecting part of the contents from the contents and selects part of the contents from the contents based on the selected given parameter.

As described above, in the receiving apparatus, the receiving method, the program and the transmitting apparatus according to the embodiments of the invention, it is possible to select that part of contents is transmitted from the transmitting apparatus to the receiving apparatus even when the battery remaining amount is small.

### BRIEF DESCRIPTION OF THE DRAWINGS

FIG. 1 is a diagram showing a configuration of a communication system according to an embodiment;

FIG. 2 is a flowchart showing the flow of processing executed by the communication system according to the embodiment;

FIG. 3 is a view showing an example of a selection screen for selecting preferential dubbing;

FIG. 4 is a view showing an example of a confirmation screen for confirming contents to be preferentially dubbed; and

FIG. 5 is a view showing an example of an attribute designation screen for selecting an attribute used for selecting contents to be preferentially dubbed.

### DESCRIPTION OF THE PREFERRED EMBODIMENTS

Hereinafter, preferred embodiments of the invention will be explained in detail with reference to the attached drawings. In the specification and the drawings, the same signs and numerals are given to components having substantially the same functional configuration to thereby omit repeated explanation.

“Modes for carrying out the invention” will be explained in the following order.

1. Embodiment
1-1. Configuration of a communication system
1-2. Flow of the whole processing
1-3. Display screen example

2. Modification example

3. Summary

### 1. Embodiment

### [1-1. Configuration of a Communication System]

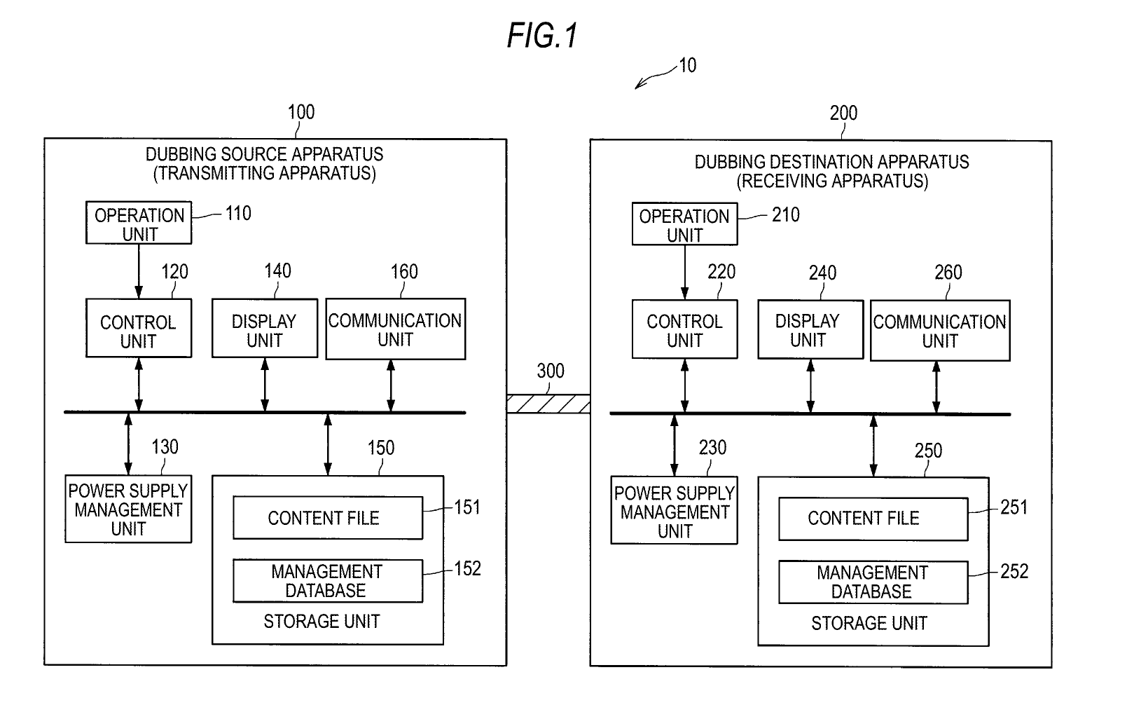

First, the flow of the whole communication system will be explained by taking a digital still camera and a camcorder as examples with reference to FIG. 1.

As shown in FIG. 1, a communication system 10 includes a dubbing source apparatus 100 which is an apparatus or a medium of a dubbing source and a dubbing destination apparatus 200 which is an apparatus or a medium of a dubbing destination. A transmission line 300 functions as a transmission line connecting the dubbing source apparatus 100 to the dubbing destination apparatus 200. As the transmission line 300, for example, a USB cable or a communication connection established in wireless communication can be used. When the dubbing destination apparatus 200 is a single medium such as an external HDD, respective blocks may be omitted, for example, when a screen is not mounted, a display unit 240 may be omitted.

As dubbing procedures according to the embodiment, first, the dubbing source apparatus 100 and the dubbing destination apparatus 200 are connected by the transmission line 300, which allows the system to perform communication. When the transmission line 300 is realized by USB connection, the dubbing source apparatus 100 mounts a storage unit 250 of the dubbing destination apparatus 200 to allow the dubbing source apparatus 100 to read or write data in the storage unit 250 of the dubbing destination apparatus 200. When the transmission line 300 is realized by wireless communication, it is necessary to establish connection as the transmission line 300 through which wireless communication can be performed with the dubbing source apparatus 100 as the transmission side and the dubbing destination apparatus 200 as the receiving side by performing handshake processing and the like necessary for performing communication between a control unit 120 and a control unit 220.

The dubbing source apparatus 100 is just an example of the transmitting apparatus, and the dubbing destination 200 is just an example of the receiving apparatus. Therefore, it is assumed that contents to be a dubbing target remain in the transmitting apparatus exemplified by the dubbing source apparatus 100, and the contents are transmitted to the receiving apparatus exemplified by the dubbing destination apparatus 100, however, the setting in which contents to be the dubbing target do not remain in the transmitting apparatus exemplified by the dubbing source apparatus 100 may be applied. Additionally, the dubbing source apparatus 100 and the dubbing destination apparatus 200 have an imaging function in the embodiment, however, to have the imaging function is not indispensable and the dubbing source apparatus 100 and the dubbing destination apparatus 200 may be other electronic apparatus and the like not having the imaging function.

First, a case where the dubbing destination apparatus 200 compares remaining drive time of the apparatus itself with time necessary for dubbing will be explained. After the explanation, a case where the dubbing source apparatus 100 compares remaining drive time of the apparatus itself with time necessary for dubbing will be explained. That is, the processing of comparing remaining drive time of the apparatus itself with time necessary for dubbing may be performed by either the dubbing source apparatus 100 or the dubbing destination device 200.

The dubbing destination apparatus 200 includes at least the control unit 220, a power supply management unit 230, the storage unit 250 and a communication unit 260. The storage unit 250 is formed by, for example, a non-volatile memory, including a content file 251 for storing contents as a file and a management database 252 for managing information such as metadata relating to contents. The communication unit 260 is formed by, for example, a communication device, having a function of performing communication with the dubbing source apparatus 100 as the transmission source of contents. The power supply management unit 230 has a function of managing a battery remaining amount used for driving the apparatus itself.

The control unit 220 is formed by, for example, a CPU and a RAM, and programs stored by the storage unit 250 is expanded in the RAM and executed by the CPU to thereby realize the function. However, it is also preferable that the control unit 220 is formed by dedicated hardware.

The control unit 220 has a function of acquiring remaining drive time of the apparatus itself calculated based on the battery remaining amount of the apparatus itself and time necessary for transmitting contents to compare the remaining drive time with the necessary time when receiving the contents from the dubbing source apparatus 100 through the communication unit 260 and recording the contents in the storage unit 250 as the content file 251. The battery remaining amount of the apparatus itself is managed by, for example, the power supply management unit 230 and can be acquired from the power supply management unit 230. A method of calculating the remaining drive time from the battery remaining amount is not particularly limited. Examples of acquiring method of time necessary for transmitting contents will be explained later.

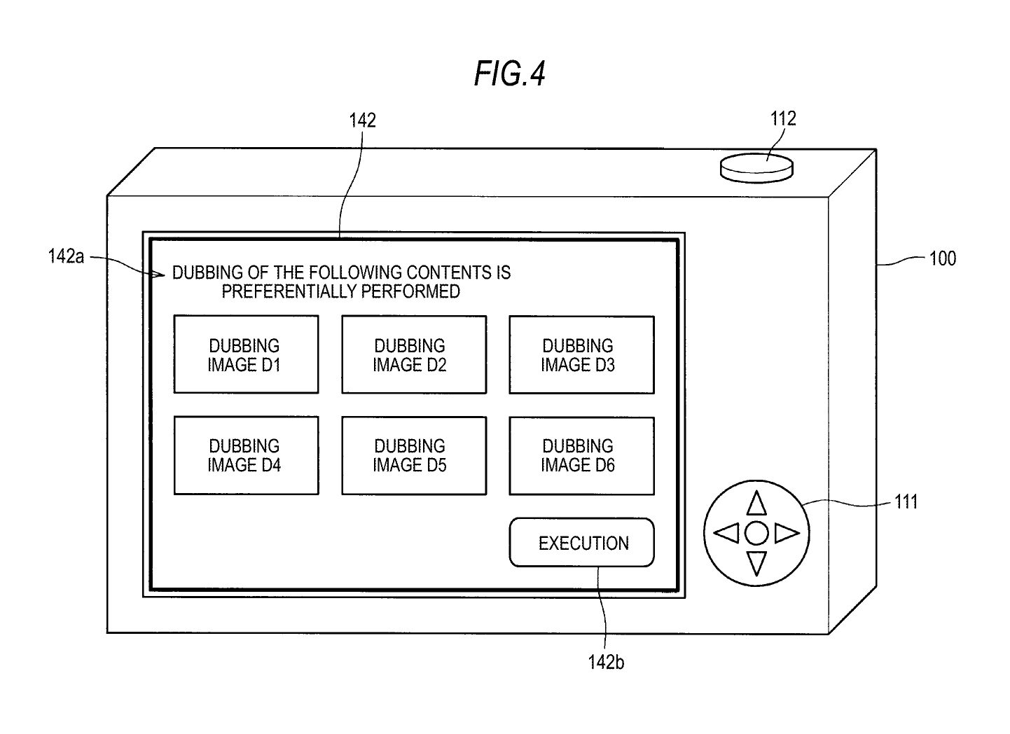

The control unit 220 also selects any one of a first mode in which part of contents is received from the dubbing source apparatus 100 through the communication unit 260 and recorded in the storage unit 250 and a second mode in which contents are not received when determining that the necessary time is longer than the remaining drive time based on the compared result. Part of contents may be one or plural units obtained by dividing one content into plural contents, or one or plural contents selected from plural contents when plural contents exist. A confirmation screen displayed for allowing a user to confirm the part of contents will be explained later with reference to FIG. 4.

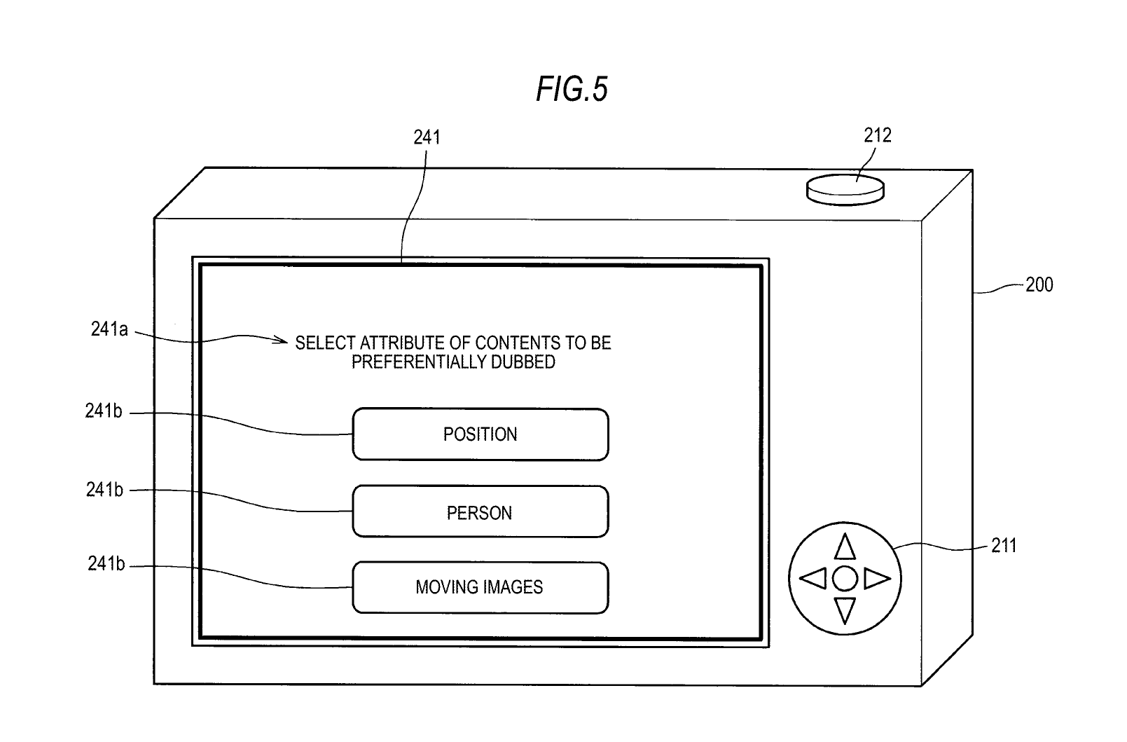

It is also preferable that the control unit 220 selects a given parameter for selecting part of contents from contents, and that the selected given parameter is transmitted to the dubbing source apparatus 100 through the communication unit 260. Accordingly, the dubbing source apparatus 100 can select part of contents based on the given parameter. As the given parameter, for example, information for identifying metadata (for example, information for identifying position information as an example of metadata) can be used. That is, the dubbing source apparatus 100 can select contents having metadata identified by information for identifying the metadata as part of contents . As examples of metadata, content additional information obtained at the time of recording contents such as face detection data, highlight point data and reproduction duration can be cited, in addition to the above. An attribute designation screen displayed for selecting the given parameter will be explained later with reference to FIG. 5.

The control unit 220 can also receive the battery remaining amount of the dubbing source apparatus 100 from the dubbing source apparatus 100 through the communication unit 260. In this case, the control unit 220 selects smaller one of remaining drive time of the dubbing source apparatus 100 and the remaining drive time of the apparatus itself calculated based on the received battery remaining amount and the selected remaining drive time can be used for comparison with respect to necessary time. That is because it is presumed that the dubbing is interrupted when the battery is exhausted at any one of the dubbing source apparatus 100 and the apparatus itself. It is also preferable that the control unit 220 can control the apparatus not to perform dubbing when it is difficult to acquire any of remaining drive time of the dubbing source apparatus 100 and remaining drive time of the apparatus itself.

Though the method of acquiring time necessary for transmitting contents is not limited, for example, necessary time can be acquired by performing calculation based on a data size of contents. For example, the time necessary for transmitting the contents can be calculated so that the time is in proportion to the data size of the content. The calculation of time necessary for transmitting contents may be performed by either the dubbing source apparatus 100 or the dubbing destination apparatus 200.

That is, the control unit 220 may receive time necessary for transmitting contents calculated based on the data size of contents from the dubbing source apparatus 100 through the communication unit 260 to acquire the received time as the necessary time. The control unit 220 receives the data size of the contents from the dubbing source apparatus 100 through the communication unit 260 and calculates time necessary for transmitting contents based on the data size of the received contents to acquire the calculated time as necessary time.

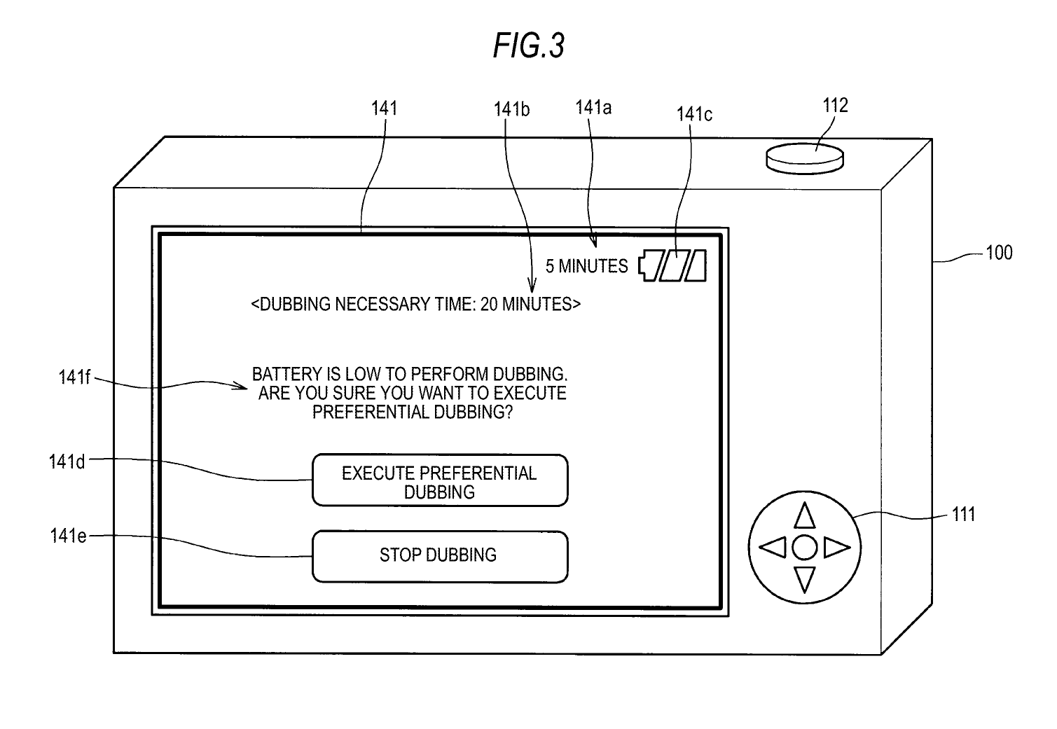

The dubbing destination apparatus 200 may further include the display unit 240 displaying a selection screen for selecting any one of the first mode and the second mode. The selection screen for selecting any one of the first mode and the second mode will be explained later with reference to FIG. 3. The display unit 240 may include necessary time in the selection screen as well as including remaining drive time in the selection screen. The display unit 240 is formed by, for example, a display device.

The dubbing destination apparatus 200 may include an operation unit 210 receiving input of operation information from the user. In that case, the control unit 220 selects any one of the first mode and the second mode based on operation information the input of which is received by the operation unit 210. The operation unit 210 is formed by an input device including buttons and so on, however, it is not particularly limited.

When the first mode is selected, the control unit 220 receives part of contents and records the contents in the storage unit 250 as the content file 251, and when the second mode is selected, the control unit 220 does not receive the contents.

Subsequently, a case where the dubbing source apparatus 100 performs the processing of comparing remaining drive time of the apparatus itself with time necessary for dubbing will be explained.

The dubbing source apparatus 100 includes at least the control unit 120, a power supply management unit 130, the storage unit 150 and a communication 160. The storage unit 150 is formed by, for example, a non-volatile memory, including a content file 151 for storing contents as a file and a management database 152 for managing information such as metadata relating to contents. The communication unit 160 is formed by, for example, a communication device, having a function of performing communication with the dubbing destination apparatus 200 which is the transmission destination of contents. The power supply management unit 130 has a function of managing the battery remaining amount used for driving of the apparatus itself.

The control unit 120 is formed by, for example, the CPU and the RAM, and programs stored by the storage unit 150 is expanded in the RAM and executed by the CPU to thereby realize the function. However, it is also preferable that the control unit 120 is formed by dedicated hardware.

The control unit 120 has a function of acquiring remaining drive time of the apparatus itself calculated based on the battery remaining amount of the apparatus itself and necessary time for transmitting contents to compare the remaining drive time with the necessary time when transmitting contents through the communication unit 160 to the dubbing destination apparatus 200. The battery remaining amount of the apparatus itself is managed by, for example, the power supply management unit 130 and can be acquired from the power supply management unit 130. A method of calculating the remaining drive time from the battery remaining amount is not particularly limited. Examples of acquiring method of necessary time for transmitting contents will be explained later.

The control unit 120 also selects any one of a first mode in which part of contents is transmitted to the dubbing destination apparatus 200 through the communication unit 160 and a second mode in which contents are not transmitted when determining that the necessary time is longer than the remaining drive time based on the compared result. A confirmation screen displayed for allowing the user to confirm the part of contents will be explained later with reference to FIG. 4.

It is also preferable that the control unit 120 selects a given parameter for selecting part of contents from contents. Accordingly, the control unit 120 can select part of contents based on the given parameter. As the given parameter, for example, information for identifying metadata (for example, information for identifying position information as an example of metadata) can be used. That is, the control unit 120 can select contents having metadata identified by information for identifying the metadata as part of contents. An attribute designation screen displayed for selecting a given parameter will be explained later with reference to FIG. 5.

Additionally, the control unit 120 may select contents having much metadata as part of contents, or may select contents having metadata to which high priority is set by the user in advance as part of contents.

The control unit 120 can also receive the battery remaining amount of the dubbing destination apparatus 200 from the dubbing destination apparatus 200 through the communication unit 160. In this case, the control unit 120 selects smaller one of remaining drive time of the dubbing destination apparatus 200 and the remaining drive time of the apparatus itself calculated based on the received battery remaining amount and the selected remaining drive time can be used for comparison with respect to necessary time. That is because it is presumed that the dubbing is interrupted when the battery is exhausted at any one of the dubbing destination apparatus 200 and the apparatus itself. It is also preferable that the control unit 120 can control the apparatus not to perform dubbing when it is difficult to acquire any of remaining drive time of the dubbing destination apparatus 200 and remaining drive time of the apparatus itself.

Though the method of acquiring time necessary for transmitting contents is not limited, for example, necessary time can be acquired by performing calculation based on the data size of contents. For example, the time necessary for transmitting the content can be calculated so that the time is in proportion to the data size of contents. The calculation of time necessary for transmitting contents may be performed by either the dubbing source apparatus 100 or the dubbing destination apparatus 200.

That is, the control unit 120 may receive time necessary for transmitting contents calculated based on the data size of contents from the dubbing destination apparatus 200 through the communication unit 160 to acquire the received time as the necessary time. The control unit 120 receives the data size of the contents from the dubbing destination apparatus 200 through the communication unit 160 and calculates time necessary for transmitting contents based on the data size of the received contents to acquire the calculated time as necessary time.

The dubbing source apparatus 100 may further include a display unit 140 displaying a selection screen for selecting any one of the first mode and the second mode. The selection screen for selecting any one of the first mode and the second mode will be explained later with reference to FIG. 3. The display unit 140 may include necessary time in the selection screen as well as including remaining drive time in the selection screen. The display unit 140 is formed by, for example, a display device.

The dubbing source apparatus 100 may include an operation unit 110 receiving input of operation information from the user. In that case, the control unit 120 selects any one of the first mode and the second mode based on operation information the input of which is received by the operation unit 110. The operation unit 110 is formed by an input device including buttons and so on, however, it is not particularly limited.

When the first mode is selected, the control unit 120 receives part of contents and records the contents in the storage unit 150 as the content file 151, and when the second mode is selected, the control unit 220 does not receive the contents.

### [1-2. Flow of the Whole Processing]

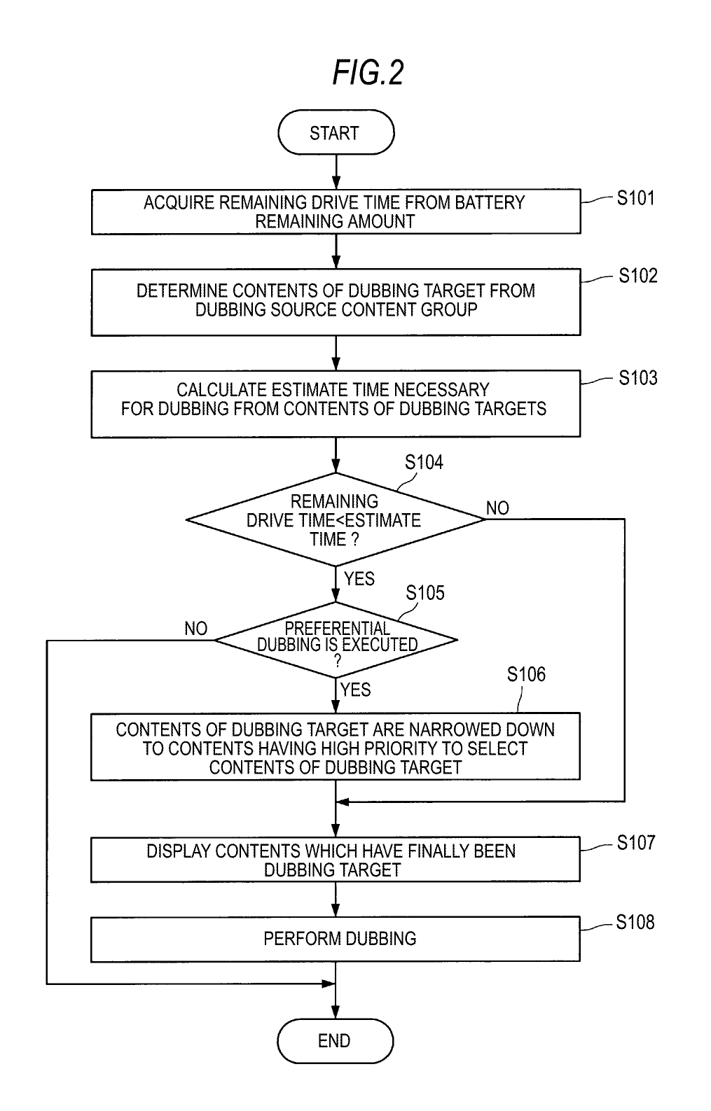

The flow of processing until executing dubbing will be shown as a flowchart in FIG. 2. In this case, an example in which Step S101 to Step S108 shown in FIG. 2 are executed by the dubbing source apparatus 100 will be explained, however, it is also preferable that the steps may be executed by the dubbing destination apparatus 200. As shown in FIG. 2, the control unit 120 acquires the power status of the dubbing source apparatus 100 from the power supply management unit 130. That is, the power supply management unit 130 determines AC connection when the dubbing source apparatus 100 is connected to an AC cable, and determines battery drive as well as outputting the battery remaining amount to the control unit 120 as the remaining drive time of the apparatus itself when the apparatus itself is driven by battery. The control unit 120 acquires the battery remaining amount as the remaining drive time of the apparatus itself when the apparatus itself is driven by the battery (Step S101).

When the dubbing destination apparatus 200 to be the receiving side is connected by wireless communication, it is presumed that the dubbing destination apparatus 200 side is also driven by the battery. In such case, the control unit 120 acquires the power status of the power supply management unit 230 of the dubbing destination apparatus 200 through the control unit 220. The control unit 120 applies any smaller one of values of remaining drive time of the dubbing source apparatus 100 which is the apparatus itself and remaining drive time of the dubbing destination apparatus 200 as the whole remaining drive time.

Subsequently, the control unit 120 determines contents to be the dubbing target from a dubbing source content group stored in the storage unit 150 (Step S102). The first determination may be made by optional selection by the user or may be made by using difference information automatically. Subsequently, the control unit 120 calculates estimation time necessary for dubbing from contents of the dubbing target (the number of contents or the data size) (Step S103). The estimation time corresponds to the necessary time. The control unit 120 compares the remaining drive time acquired in Step S101 with the estimation time calculated in Step S103 (Step S104) and when the estimation time is larger (“Yes” in Step S104), the process proceeds to Step S105. When the estimated time is within the remaining drive time (“No” in Step S104), the process proceeds to Step S107, where the dubbing is executed (Step S108).

In Step S105, it is preferable to notify the user of battery shortage for dubbing the determined contents of the dubbing target as well as to display a screen for selecting whether preferential dubbing is executed or not. More preferably, a selection screen 141 shown in FIG. 3 is displayed by the display unit 140 of the dubbing source apparatus 100. In the example shown in FIG. 3, the display unit 140 of the dubbing source apparatus 100 displays a remaining drive time 141a calculated from a dubbing necessary time 141b and a battery remaining amount 141c at the same time to thereby indicate the battery shortage to the user as well as notifying the user of the necessity of preferential dubbing as UI information.

When the user selects the execution of preferential dubbing, the process proceeds to Step S106. The control unit 120 further selects contents from contents of the dubbing target determined in Step S102 so that the estimation time falls within the remaining drive time (Step S106). In the selection, the control unit 120 decides contents having high priority, calculates estimation time again and repeats selection so that the estimation time falls within the remaining drive time. As contents having high priority, contents mainly having metadata (face, GPS, highlight climax point data, user setting mark data) are determined. Much metadata remains in these contents when the user recorded the contents, therefore, it is found that these contents are important for the user and desirable to be backed up preferentially. In the embodiment, the dubbing is performed to the greatest extent possible even when the battery remaining amount is small, therefore, the dubbing is performed from the content having high priority. After the dubbing target is determined in Step S106, the process proceeds to step S107.

The selection of contents may be made so as to give priority to the contents having metadata selected by the user. An attribute designation screen 241 for selecting metadata by the user is displayed by, for example, the display unit 240 of the dubbing destination apparatus 200 as shown in FIG. 5. When the user selects a desired attribute from attributes displayed on the attribute designation screen 241, metadata corresponding to the selected attribute is transmitted to the dubbing source apparatus 100, and contents having the metadata are selected by the dubbing source apparatus 100.

As shown in FIG. 4, the display unit 140 displays a content group which has finally been the dubbing target on a confirmation screen 142 and prompts the user to check the screen when preferential dubbing is performed. The content group is displayed, for example, in a list as thumbnails of respective contents as shown in FIG. 4. After that, the process proceeds to Step S108 when the user selects the dubbing and the dubbing is performed (Step S108). However, when the communication system 10 performs dubbing automatically, the process may proceed to Step S108 and perform the dubbing without changing the screen of Step S107.

### [1-3. Display Screen Example]

An example of the selection screen for selecting the preferential dubbing is shown in FIG. 3. As described above, the selection screen 141 for selecting any one of the first mode and the second mode is displayed by the display unit 140 of the dubbing source apparatus 100. Though the selection screen 141 is displayed by the display unit 140 of the dubbing source apparatus 100, the selection screen 141 may be displayed by the display unit 240 of the dubbing destination apparatus 200. The selection screen 141 includes at least an object 141d for selecting the first mode and an object 141e for selecting the second mode.

When the user inputs operation information for selecting the object 141d through a controller 111 and the like, the operation information is received by the control unit 120 and the first mode is selected based on the operation information. Similarly, when the user inputs operation information for selecting the object 141e through the controller 111 and the like, the operation information is received by the control unit 120 and the second mode is selected based on the operation information. The controller 111 is included in, for example, the operation unit 110.

Additionally, the selection screen 141 may include the remaining drive time 141a, the dubbing necessary time 141b, the battery remaining 141c and so on. A message 141f saying “Battery is low to perform dubbing. Are you sure you want to execute preferential dubbing?” and so on can be included in the selection screen 141. A shutter button 112 is for performing imaging by being pressed by the user, and is not inevitable.

An example of the confirmation screen for confirming contents to be preferentially dubbed is shown in FIG. 4. As described above, the confirmation screen 142 for allowing the user to confirm part of contents is displayed by the display unit 140 of the dubbing source apparatus 100. Though the confirmation screen 142 is displayed by the display unit 140 of the dubbing source apparatus 100 in this case, the confirmation screen 142 may be displayed by the display unit 240 of the dubbing destination apparatus 200. The confirmation screen 142 includes at least an object 142b for selecting execution of preferential dubbing. Part of contents is included in the confirmation screen 142 as thumbnail images (dubbing images D1 to D6).

Assume that the user confirms part of contents and decides to perform dubbing of part of contents preferentially. In this case, when the user inputs operation information for selecting the object 142b through the controller 111 and the like, the operation information is received by the control unit 120 and the preferential dubbing is selected based on the operation information. When the preferential dubbing is selected, the preferential dubbing is executed. The preferential dubbing means that dubbing of part of contents is performed from the dubbing source apparatus 100 to the dubbing destination apparatus 200. It is also possible to include a message 142a saying “dubbing of the following contents is preferentially performed” and so on in the confirmation screen 142.

An example of the attribute designation screen for selecting an attribute used for selecting contents to be preferentially dubbed is shown in FIG. 5. As described above, the attribute designation screen 241 displayed for selecting a given parameter is displayed by the display unit 240 of the dubbing destination apparatus 200. Though the attribute designation screen 241 is displayed by the display unit 240 of the dubbing destination apparatus 200, the attribute designation screen 241 may be displayed by the display unit 140 of the dubbing source apparatus 100. The attribute designation screen 241 includes at least an object 241b for selecting the attribute.

Assume that the user confirms part of contents and decides the attribute of the contents to be preferentially dubbed. In this case, when the user inputs operation information for selecting the object 241b through the controller 111 and the like, the operation information is received by the control unit 220 and the attribute is selected based on the operation information. When the attribute is selected, the selected attribute is transmitted as the parameter (information for identifying metadata) to the dubbing source apparatus 100 through the communication unit 260. It is also possible to include a message 241a saying “Select attribute of contents to be preferentially dubbed” and so on in the attribute designation screen 241.

### <2. Modification Example>

The preferred embodiments of the invention have been explained in detail with reference to the attached drawings as the above, and the invention is not limited to the above embodiments. It is obvious that those skilled in the technical field to which the invention belongs can reach various alternation examples or modification examples within a scope of technical ideas described in claims, and it would be understood that these examples belong to the technical scope of the invention.

For example, the case where the dubbing source apparatus 100 and the dubbing destination apparatus 200 are connected by USB connection or the case where they are connected by wireless communication have been explained in the embodiment, however, the technique according to the embodiment can be also applied to a case where dubbing between media is performed in a single apparatus. Additionally, the technique according to the embodiment can be applied also to a case where the dubbing destination apparatus 200 is a medium existing on a network through a NAS.

### <3. Brief>

According to the embodiments, it is possible to select that part of contents is transmitted from the transmitting apparatus to the receiving apparatus even when the battery remaining amount is small. It is also possible to automatically determine contents having high priority for the user, and the dubbing or transmission of contents can be executed within a range in which the processing can be performed by the battery drive.

The present application contains subject matter related to that disclosed in Japanese Priority Patent Application JP 2010-070263 filed in the Japan Patent Office on Mar. 25, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A receiving apparatus comprising:
a communication unit performing communication with a transmitting apparatus as a transmission source of contents; and
a control unit acquiring remaining drive time of the apparatus itself calculated based on a battery remaining amount of the apparatus itself and time necessary for transmitting the contents to compare the remaining drive time with the necessary time when receiving the contents from the transmitting apparatus through the communication unit and recording the contents in a storage unit, and selecting any one of a first mode in which part of the contents is received from the transmitting apparatus through the communication unit and recorded in the storage unit and a second mode in which reception of the contents is not performed when determining that the necessary time is longer than the remaining drive time based on the compared result.

2. The receiving apparatus according to claim 1,
wherein the control unit selects a given parameter for selecting part of the contents from the contents and transmits the selected given parameter to the transmitting apparatus through the communication unit.

3. The receiving apparatus according to claim 1,
wherein the control unit receives the battery remaining amount of the transmitting apparatus from the transmitting apparatus through the communication unit and selects any smaller one of remaining drive time of the transmitting apparatus calculated based on the received battery remaining amount and the remaining drive time of the apparatus itself to be used for comparison between the selected remaining drive time and the necessary time.

4. The receiving apparatus according to claim 1,
wherein the control unit receives time necessary for transmitting the contents calculated based on a data size of the contents from the transmitting apparatus through the communication unit and acquires the received time as the necessary time.

5. The receiving apparatus according to claim 1,
wherein the control unit receives a data size of the contents from the transmitting apparatus through the communication unit and calculates time necessary for transmitting the contents based on the data size of the received contents to acquire the calculated time as the necessary time.

6. The receiving apparatus according to claim 1, further comprising:
a display unit displaying a selection screen for selecting any one of the first mode and the second mode.

7. The receiving apparatus according to claim 6,
wherein the display unit includes the necessary time in the selection screen as well as including the remaining drive time in the selection screen.

8. The receiving apparatus according to claim 1, further comprising:
an operation unit receiving input of operation information from a user,
wherein the control unit selects any one of the first mode and the second mode based on the operation information the input of which is received by the operation unit.

9. The receiving apparatus according to claim 1,
wherein the control unit receives part of the contents and stores the contents in the storage unit when selecting the first mode, and does not receive the contents when selecting the second mode.

10. A receiving method comprising the step of:
allowing a control unit of a receiving apparatus including a communication unit performing communication with a transmitting apparatus as a transmission source of contents and the control unit to
acquire remaining drive time of the apparatus calculated based on a battery remaining amount of the apparatus and time necessary for transmitting the contents to compare the remaining drive time with the necessary time when receiving the contents from the transmitting apparatus through the communication unit and recording the contents in a storage unit; and
select any one of a first mode in which part of the contents is received from the transmitting apparatus through the communication unit and recorded in the storage unit and a second mode in which reception of the contents is not performed when determining that the necessary time is longer than the remaining drive time based on the compared result.

11. A program for allowing a computer to function as a receiving apparatus including
a communication unit performing communication with a transmitting apparatus as a transmission source of contents, and
a control unit acquiring remaining drive time of the apparatus itself calculated based on a battery remaining amount of the apparatus itself and time necessary for transmitting the contents to compare the remaining drive time with the necessary time when receiving the contents from the transmitting apparatus through the communication unit and recording the contents in a storage unit, and selecting any one of a first mode in which part of the contents is received from the transmitting apparatus through the communication unit and recorded in the storage unit and a second mode in which reception of the contents is not performed when determining that the necessary time is longer than the remaining drive time based on the compared result.

12. A transmitting apparatus comprising:
a communication unit performing communication with a receiving apparatus as a transmission destination of contents; and
a control unit acquiring remaining drive time of the apparatus itself calculated based on a battery remaining amount of the apparatus itself and time necessary for transmitting the contents to compare the remaining drive time with the necessary time when transmitting the contents to the receiving apparatus through the communication unit, and selecting any one of a first mode in which part of the contents is transmitted to the receiving apparatus through the communication unit and recorded in a storage unit of the receiving apparatus and a second mode in which transmission of contents is not performed when determining that the necessary time is longer than the remaining drive time based on the compared result.

13. The transmitting apparatus according to claim 12,
wherein the control unit selects a given parameter for selecting part of the contents from the contents and selects part of the contents from the contents based on the selected given parameter.
